(19) United States
(12) Patent Application Publication
(10) Pub. No.: US 2008/0191778 A1
(43) Pub. Date: Aug. 14, 2008

(54) GM/C TUNING CIRCUIT AND FILTER USING THE SAME

(75) Inventors: Chih-chien Huang, Yunlin Hsien (TW); Chien Ming Chen, Hsin-Chu City (TW); Shang-Yi Lin, Hsinchu Hsien (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: MEDIATEK INC., Hsin-Chu (TW)

(21) Appl. No.: 11/673,229

(22) Filed: Feb. 9, 2007

(51) Int. Cl. G06G 7/18

(52) U.S. Cl. 327/336

(57) ABSTRACT

A Gm/C tuning circuit. The Gm/C tuning circuit comprises an integrator, a transconductance amplifier, and a switched capacitor circuit. The integrator has a first input terminal, a second input terminal, and an output terminal providing a control voltage. The transconductance amplifier receives the control voltage and a first input voltage proportional to a reference voltage and has an output terminal coupled to the first input terminal the integrator. The switched capacitor circuit has an input receiving a second input voltage proportional to the reference voltage and an output coupled to the first input terminal of the integrator.

### BACKGROUND OF THE INVENTION

1. Field of the Invention

The invention relates to a Gm-C filter and, in particular, to a Gm-C filter with a Gm/C tuning circuit.

2. Description of the Related Art

Generally, filters with constant group delay and equalization are arranged in a data read channel. The filter reduce noise from a signal band and remove ISI effect in a data read channel. Such filters with constant group dealy and equalization are typically implemented with a Gm/C filter. A corner frequency Fc of the Gm/C filter is proportional to Gm/C. Gm/C is mainly influenced by process, voltage, and temperature, or PVT. As a result, Fc changes with variation in such parameters and error rate of data read is thus influenced. Accordingly, one requirement of the filter with constant group dealy and equalization is that Fc remains constant when there is variation in PVT. In other words, Gm/C does not change with variation in PVT.

In conventional technologies, in addition to the filter, a self-tuning mechanism maintains Gm/C at a constant even when there is variation in process or temperature. Such self-tuning mechanism is typically implemented with an analog PLL with a voltage controlled oscillator (VCO), a phase/frequency detector (PFD), a charge pump, and a loop filter or a digital PLL with a voltage controlled oscillator (VCO), a frequency detector (FD), and a digital to analog converter (DAC), as shown in FIGS. 1 and 2.

In FIG. 1, the VCO in the analog PLL is a Gm/C VCO and the Gm/C thereof is proportional to a control voltage. Thus, the output frequency of the Gm/C VCO is proportional to Gm/C. The analog PLL locks the output frequency of the Gm/C type VCO at a reference clock frequency. As temperature increases, transconductance Gm drops such that the output frequency of Gm/C type VCO becomes lower than the reference clock frequency. Then, the control voltage is accordingly increased due to negative feedback nature of the analog PLL, as is transconductance Gm. As a result, Gm/C is kept at a constant. In addition, the control voltage is also transferred to a Gm/C filter such that a corner frequency Fc thereof is controlled. When the temperature decreases, transconductance Gm increases such that the output frequency of Gm/C VCO exceeds the reference clock frequency. Then, the control voltage is reduced accordingly due to negative feedback of the analog PLL, as is transconductance Gm. As a result, Gm/C is kept at a constant. In addition, the control voltage is also transferred to a Gm/C type filter such that a corner frequency Fc thereof is controlled. Similarly, if capacitance C is influenced by PVT, negative feedback of the analog PLL maintains Gm/C at a constant. Operating principles and functions of the digital PLL are similar to the analog PLL.

The Gm/C is self-tuned by a Gm/C VCO. Since a Gm/C VCO requires several stages of Gm/C circuits, chip area is thus increased as is cost.

FIG. 3 is a schematic diagram of another conventional circuit for Gm/C tuning. When a first switch SW1 is turned on, a capacitor C₁ is charged to a voltage V_{c}=I_{R}/Gm and charge capacity stored in the capacitor C₁ is C₁×I_{R}/Gm. When a second switch SW2 is turned on, the charge stored in the capacitor C₁ is transferred to an integrator, and a voltage change ΔV in the voltage V_{c} is −I_{R}×C₁/Gm/C₂, wherein C₂ is a capacitance of the capacitor in the integrator. Since a current of NI_{R} flows through the integrator within a time period of 1/f, wherein f is a frequency of control signals of the first and second switches SW1 and SW2, a voltage change ΔV₁ in the voltage V_{c} is −NI_{R}/C₂×1/f. Due to negative feedback nature of the integrator, a net change ΔV+ΔV₁ of the voltage V_{c} is zero. As a result, a transcondcutance to capacitance ratio (Gm/C₁) equals f/N.

### BRIEF SUMMARY OF THE INVENTION

An embodiment of a Gm/C tuning circuit comprises an integrator, a transconductance amplifier, and a switched capacitor circuit. The integrator has a first input terminal, a second input terminal, and an output terminal. The transconductance amplifier has a control terminal coupled to the output terminal of the integrator and an output terminal coupled to the first input terminal the integrator. The switched capacitor circuit has an input and an output coupled to the first input terminal of the integrator.

Another embodiment of a filter comprises the disclosed Gm/C tuning circuit and a Gm/C filter coupled to the output terminal of integrator in the disclosed Gm/C tuning circuit.

Another embodiment of a Gm/C tuning circuit comprises an integrator, a transconductance amplifier, and a switched capacitor circuit. The integrator has a first input terminal, a second input terminal, and an output terminal providing a control voltage. The transconductance amplifier receives the control voltage and a first input voltage proportional to a reference voltage and has an output terminal coupled to the first input terminal of the integrator. The switched capacitor circuit has an input receiving a second input voltage proportional to the reference voltage and an output coupled to the first input terminal of the integrator.

Another embodiment of a filter comprises the disclosed Gm/C tuning circuit and a Gm/C filter coupled to the disclosed Gm/C tuning circuit and controlled by the control voltage.

The invention provides a Gm-C type filter with Gm/C self tuned by a feedback circuit with a transconductance amplifier and a switched capacitor circuit. As a result, the large area occupied by conventional voltage controlled oscillators is not required.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a schematic diagram of a conventional filter with Gm/C self-tuning;

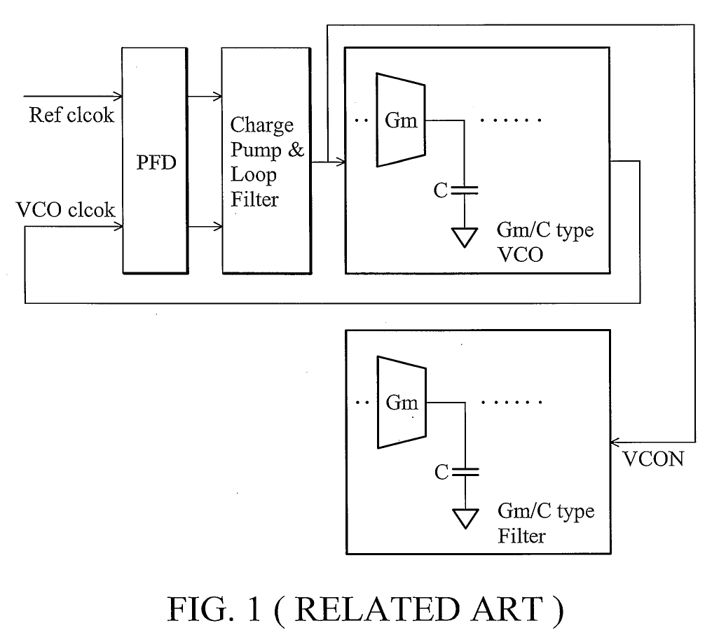

FIG. 2 is a schematic diagram of another conventional filter with Gm/C self-tuning;

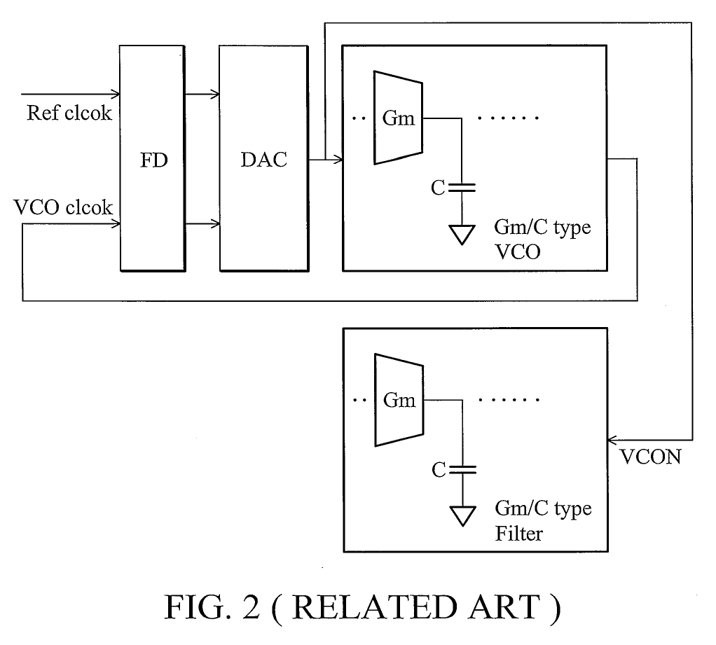

FIG. 3 is a schematic diagram of a conventional circuit for Gm/C tuning;

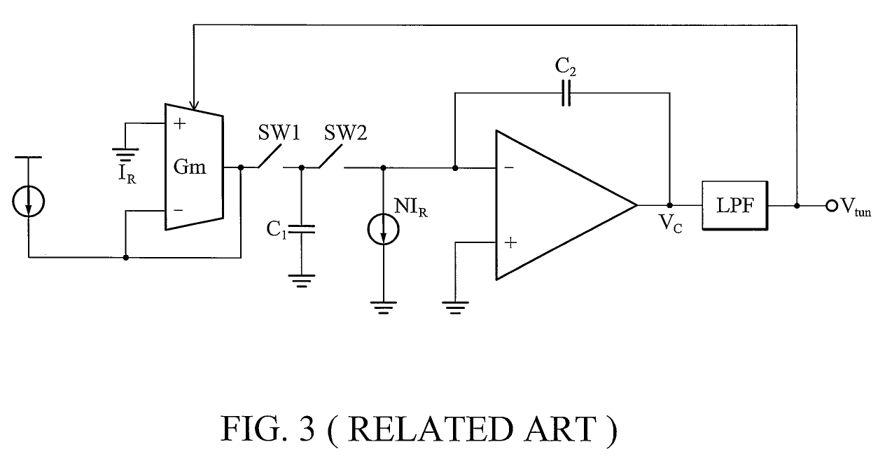

FIG. 4 is a schematic diagram of a filter with Gm/C tuning according to an embodiment of the invention;

FIG. 5 shows waveforms of the control signals CLK1 and CLK2 of the first and second switches SW1 and SW2 in FIG. 4

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

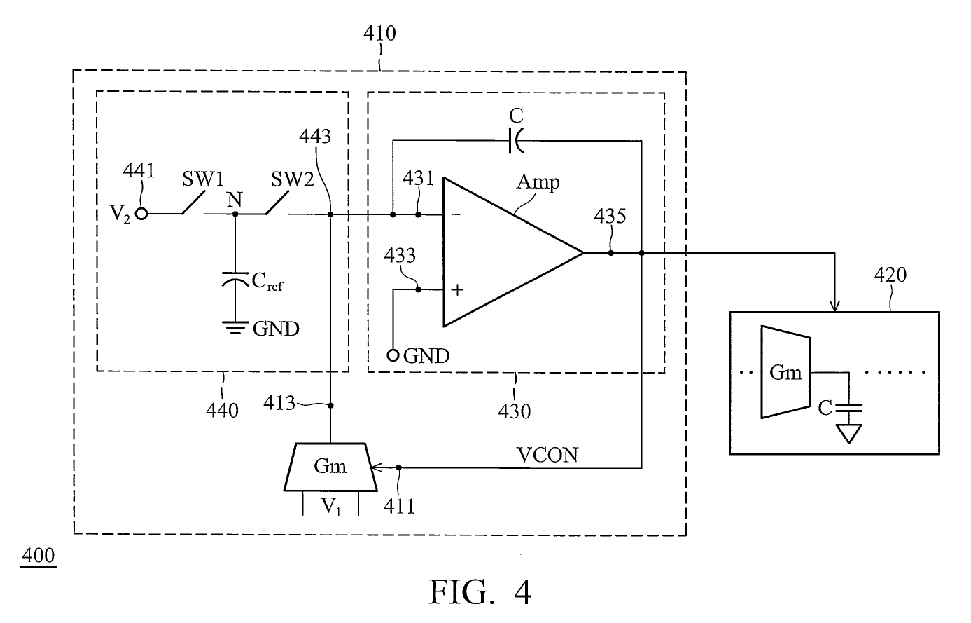

FIG. 4 is a schematic diagram of a filter with Gm/C tuning according to an embodiment of the invention. The filter 400 comprises a Gm/C tuning circuit 410 and a Gm-C filter 420. The Gm/C tuning circuit 410 comprises an integrator 430, a transconductance amplifier Gm, and a switched capacitor circuit 440. The integrator 430 has a first input terminal 431, a second input terminal 433, and an output terminal 435 providing a control voltage VCON. The transconductance amplifier Gm receives the control voltage VCON and a first input voltage V₁ proportional to a reference voltage Vref (V₁=K₁×Vref) and generates a current according thereto. A control terminal 411 of the transconductance amplifier Gm is coupled to the output terminal 435 of the integrator 430 and an output terminal 413 thereof is coupled to the first input terminal 411 of the integrator 430. The switched capacitor circuit 440 has an input 441 receiving a second input voltage V₂ proportional to the reference voltage Vref (V₂=K₂×Vref ) and an output 443 coupled to the first input terminal 411 of the integrator 430. The Gm-C type filter 420 is coupled to the Gm/C tuning circuit 410 and controlled by the control voltage VCON.

In FIG. 4, the integrator 430 comprises an amplifier and a capacitor C. The amplifier has an inverting input, marked as −, a non-inverting input, marked as +, coupled to a reference, and an output respectively corresponding to the first input terminal 431, the second input terminal 433, and the output terminal 435 of the integrator 430. The capacitor C is coupled between the inverting input—and the output of the Amp.

In addition, in FIG. 4, the switched capacitor circuit 440 comprises a capacitor Cref, a first switch SW1, and a second switch SW2. The capacitor Cref is coupled between a node N and a ground GND. The first switch SW1 is coupled to the node N and receives the second input voltage V₂ proportional to the reference voltage Vref (V₂=K₂×Vref). The second switch SW2 is coupled between the node N and the first input terminal 431 of the integrator 430. Control signals CLK1 and CLK2 of the first and second switches SW1 and SW2 are non-overlap clocks with a reference frequency Fref. The term “non-overlap clock” used herein means that when one of the first and second switches SW1 and SW2 is turned on, the other thereof is turned off.

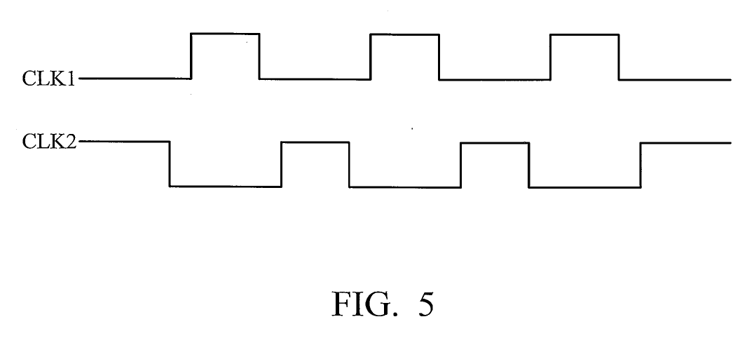

FIG. 5 shows waveforms of the control signals CLK1 and CLK2 of the first and second switches SW1 and SW2 in FIG. 4. When the control signal CLK1 of first switch SW1 is high, the first switch SW1 is turned on and the capacitor Cref is charged to the second input voltage V₂. Thereafter, when the control signal CLK2 of second switch SW2 is high, the second switch SW2 is turned on and the charge stored in the capacitor Cref is transferred to the first input terminal 431 of the integrator 430. Due to negative feedback nature, the first input terminal 431 of the integrator 430 is virtually short with the terminal 433. As a result, the charge from the switched capacitor circuit is completely absorbed by the transcondcutance amplifier Gm, leading to the formula Cref×K2×Vref=K1×Vref×Gm×1/Fref, which shows that Gm/Cref is fixed at a constant K2/K1×Fref. Since the Gm cell and Capacitor in Gm-C type filter 420 is in the proximity of the Gm/C tuning circuit 410 and controlled by the control voltage VCON, a transconductance to capacitance ratio (Gm/C) is also fixed at K2/K1×Fref.

The invention provides a Gm-C type filter with Gm/C self tuned by a feedback circuit with a transconductance amplifier and a switched capacitor circuit. As a result, the large area occupied by conventional voltage controlled oscillators is not required.

While the invention has been described by way of example and in terms of preferred embodiment, it is to be understood that the invention is not limited thereto. To the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A Gm/C tuning circuit, comprising:
an integrator having a first input terminal, a second input terminal, and an output terminal;
a transconductance amplifier having a control terminal coupled to the output terminal of the integrator and an output terminal coupled to the first input terminal the integrator; and
a switched capacitor circuit having an input and an output coupled to the first input terminal of the integrator.

2. The Gm/C tuning circuit as claimed in claim 1, wherein the integrator comprises an operational amplifier, having an inverting input as the first input terminal, a non-inverting input coupled to a ground as the second input terminal, and an output as the output terminal, and a capacitor coupled between the inverting input and the output thereof.

3. The Gm/C tuning circuit as claimed in claim 1, wherein the switched capacitor circuit comprises a capacitor coupled between a node and a ground, a first switch coupled to the node, and a second switch coupled between the node and the first input terminal of the integrator, wherein control signals of the first and second switches are non-overlap clocks.

4. A filter comprising Gm/C tuning circuit as claimed in claim 1 and a Gm/C type filter coupled to the output terminal of the integrator in the Gm/C tuning circuit.

5. A Gm/C tuning circuit, comprising:
an integrator having a first input terminal, a second input terminal, and an output terminal providing a control voltage;
a transconductance amplifier receiving the control voltage and a first input voltage proportional to a reference voltage and having an output terminal coupled to the first input terminal the integrator; and
a switched capacitor circuit having an input receiving a second input voltage proportional to the reference voltage and an output coupled to the first input terminal of the integrator.

6. The Gm/C tuning circuit as claimed in claim 1, wherein the integrator comprises an operational amplifier, having an inverting input as the first input terminal, a non-inverting input coupled to a ground as the second input terminal, and an output as the output terminal, and a capacitor coupled between the inverting input and the output thereof.

7. The Gm/C tuning circuit as claimed in claim 1, wherein the switched capacitor circuit comprises a capacitor coupled between a node and a ground, a first switch coupled to the node and receiving the second input voltage, and a second switch coupled between the node and the first input terminal of the integrator, wherein control signals of the first and second switches are non-overlap clocks.

8. A filter comprising Gm/C tuning circuit as claimed in claim 1 and a Gm/C filter coupled thereto and controlled by the control voltage.
